(19) United States
(12) Patent Application Publication
(10) Pub. No.: US 2006/0173116 A1
(43) Pub. Date: Aug. 3, 2006

(54) Gas bag module

(75) Inventor: Martin Kreuzer, Kleinwallstadt (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/336,075

(22) Filed: Jan. 20, 2006

(30) Foreign Application Priority Data
Feb. 3, 2005 (DE) 10 2005 005 042.5

(51) Int. Cl. C08K 9/04; B60R 21/16

(52) U.S. Cl. 524/445; 280/728.1

(57) ABSTRACT

A gas bag module for a vehicle occupant restraint system comprises a gas generator, a carrier part for the gas generator, a gas bag associated with the gas generator and a covering for the gas bag. The carrier part or the covering or both comprise at least one layer composed of a polymer matrix and exfoliated layered silicate particles dispersed therein, the exfoliated layered silicate particles having a thickness of 0.5 to 2 nm and a surface diameter of up to 10 μm.

### TECHNICAL FIELD OF THE INVENTION

The invention relates to a gas bag module for a vehicle occupant restraint system.

### BACKGROUND OF THE INVENTION

Nowadays, the frame and carrier parts of gas bag modules and also the gas bag coverings are produced by means of injection moulding or other moulding processes for plastics. The carrier parts of the gas bag module serve to receive a gas generator and for fastening the module on the vehicle side. The gas bag covering closes the module towards the interior of the vehicle. The covering is provided on its inner side facing the gas bag with a so-called tear line which acts as a break-off point upon activation of the gas bag by the gas generator and makes the folding open of the covering possible. The expanding gas bag can thereby emerge from the module and prevent an impact of the vehicle occupant onto the steering wheel column, the instrument panel or the windscreen.

The coverings usually consist of a thermoplastic synthetic material, such as polyurethane. Thermoplastic elastomers of the group of thermoplastic olefins (TPO), thermoplastic esters (TPEE), thermoplastic polyurethanes (TPU) and of the styrene-modified materials (SEBS) also come into use. EP 0 779 185 B1 describes coverings which have as their main component one or more layers in a composite structure, of a material which is selected from the group consisting of elastomer alloys of a thermoplastic polymer with a non-cross-linked, partially cross-linked or fully cross-linked EPDM terpolymer, the block copolymers of alternating polyester and polyether blocks and also the block copolymers of polystyrene and polyolefins.

Thermoplastic polymers of polyamide and plastics reinforced with fibres are usually used for the production of the carrier and frame parts of the gas bag module.

The carrier parts and coverings made of the thermoplastic polymers or thermoplastic elastomers have proved to be successful in practice and also fulfil the current requirements at the threshold temperatures between −35 degrees C. and +85 degrees C. Under real temperature test conditions in the environmental test chamber, however, an increase in embrittlement and hence an impairment to the mechanical properties can be observed particularly in the low temperature range.

### SUMMARY OF THE INVENTION

It is, therefore, an object of the invention to provide a gas bag module for a vehicle occupant restraint system in which the above disadvantages are avoided, wherein the components of the gas bag module have an improved embrittlement behaviour at low temperatures and an improved resistance to changes in temperature.

According to the present invention the gas bag module comprises a gas generator, a carrier part for the gas generator, a gas bag associated with the gas generator and a covering for the gas bag. At least one of the carrier part and the covering comprises at least one layer composed of a polymer matrix and exfoliated layered silicate particles (phyllosilicate particles) uniformly dispersed in said polymer matrix, the exfoliated layered silicate particles having a thickness of 0.5 to 2 nm and a surface diameter of up to 10 μm, preferably between about 100 nm and 1 μm.

The use of plastics which are filled in accordance with the invention with the platelet-shaped exfoliated phyllosilicate particles in the production of the supporting parts and also the covering of the gas bag module leads to an improvement in almost all the mechanical properties of these components. In particular, a distinct increase can be observed in the modulus of elasticity, the yield stress and the temperature resistance of the filled plastics. Furthermore, the surface quality of the components and their liability to contamination and also the deformation resistance to heat and the flame resistance characteristics are improved. As the components also do not become brittle at low temperatures in the range of −35 degrees C. and with multiple temperature changes between −35 degrees C. and +85 degrees C. in the environmental test chamber, they can also receive greater loads at these temperatures. The functional reliability of the components is thereby also ensured particularly at low temperatures.

The exfoliated layered silicate particles are preferably present in a proportion of 0.5 to 10 parts by weight, particularly preferably from 1 to 6 parts by weight per 100 parts by weight of the polymer matrix. The layered silicates (phyllosilicates) used as the starting material to form exfoliated layered silicate particles are preferably selected from the group of natural or synthetic double-layered or triple-layered silicates which are suitable for ion exchange. Montmorrilonite, saponite, beidelite, nontronite, sauconite, stevensonite and hectorite, and also bentonite, vermiculite, halloysite, kaolin, calcium methasilicate or synthetic smectite such as fluorosmectite are typical representatives. The layered silicates preferably have an ion exchange capacity of at least 20 to 200 meq/100 g (milliequivalents in relation to 100 g solid content). The ion exchange capacity indicates the concentration of ions which are able to be substituted by solutions of neutral salts from the layered silicate surface through a stoichiometric ion exchange mechanism.

The surface of the layered silicate particles is preferably hydrophobized through ion exchange with organic onium compounds such as, for example, ammonium compounds (NR₄⁺), phosphonium compounds (PR₄⁺), oxonium compounds (R₃O⁺), diazonium compounds (RN₂⁺), arsonium compounds (AsR₄⁺) and sulfonium compounds (R₃S⁺). The radicals R of the organic onium compound may be identical or different and are selected from the group consisting of hydrogen, substituted and unsubstituted, saturated and unsaturated alkyl groups having 1 to 40 carbon atoms, the alkyl groups being linear or branched, as well as substituted and unsubstituted aryl groups and benzyl groups, at least one organic radical R being a saturated or unsaturated alkyl group having at least 6 carbon atoms, which is unsubstituted or is substituted with functional groups.

The quaternary ammonium compounds which are derived from lactams or ω-amino acids and derivatives thereof are preferred.

The moulding material comprising the polymers filled with the exfoliated layered silicate particles can be formed through adding of the layered silicates, preferably hydrophobized layered silicates, before, during or after the polymerization of the monomers to the polymer matrix. An addition after the polymerization preferably takes place to the melt of the matrix polymer in an extruder. The layered silicates are exfoliated, i.e. delaminated, by the shearing forces acting during extrusion, and the platelet-shaped layered silicate particles resulting therefrom are distributed uniformly in the polymer matrix. The polymer matrix may consist of the polymers which are basically known for the production of gas bag coverings or gas generator carriers. Thermoplastic polymers such as polyurethane and polyamide, and also thermoplastic olefins, polyesters and styrene-modified materials, including the thermoplastic elastomer compositions such as are known from EP 0 779 185 B1, are suitable.

The polymer matrix may additionally contain further fibrous reinforcement materials and/or mineral fillers. Glass fibres, carbon fibres, aramid fibres, mineral fibres and whiskers are suitable as fibrous reinforcement material. Calcium carbonate, dolomite, calcium sulphate, mica, fluormica, wollastonite, talcum and kaolin and also oxides and oxide hydrates of boron, aluminium, gallium, indium, silicon, tin, titanium, zirconium, zinc, yttrium or iron can be used as mineral fillers. The additional fillers are preferably present in a proportion of up to 30 parts by weight, in relation to 100 parts by weight of the polymer matrix, and in fact in addition to the exfoliated layered silicate particles.

Finally, a coupling agent for bonding the exfoliated layered silicate particles with the polymer matrix can be contained in the polymer matrix. Preferably, the coupling agent is selected from the group consisting of organosilanes and polysiloxanes with terminal functional groups, such as for example aminosilanes, vinylsilanes, glyzidoxysilanes or polysiloxanols, which on the one hand can bond chemically to the inorganic layered silicate particles and on the other hand to the organic polymer matrix. The coupling agents may be used in addition to the above-mentioned onium compounds or, when functionalized accordingly, may also be used instead of the organic onium compounds. In addition, the coupling agents may also be linked indirectly to the exfoliated layered silicate particles via functional groups of the onium compound. With the use of the coupling agents, a further improvement to the mechanical properties of the shaped parts according to the invention is to be expected.

The moulding materials obtained by compounding into the polymer matrix the layered silicates, which were preferably hydrophobized and optionally further modified by the admixing of coupling agents, can be processed by known casting or injection moulding methods into moulded parts such as the gas bag coverings according to the invention or carrier parts of a gas bag module. The moulded parts which are thus obtained do not become brittle even at low temperatures and can therefore also still receive high loads in the threshold temperature range of −35 degrees C.

Further advantages of the invention will be apparent from the following description of a preferred embodiment which, however, is not to be understood in a restrictive sense.

### DESCRIPTION OF A PREFERRED EMBODIMENT OF THE INVENTION

3 parts by weight of a layered silicate which has been hydrophobized (bentonite, hydrophobized with dimethyldioctadecylammonium chloride; surface diameter >1 μm, layer thickness 0.5 to 2 nm) and 100 parts by weight polyamide 6 (Ultramid™ B5 Natur, BASF) were firstly homogenized in a mixer and then compounded on a twin screw extruder at approximately 260 degrees C., extruded into a water bath and granulated. Samples were cast from the granulate which was thus obtained, and were subjected to a temperature change test in the environmental test chamber in the range between −35 degrees C. and 85 degrees C. Even after multiple temperature changes, no change to the mechanical properties of the samples could be established.

Comparative tests with pure polyamide 6 (Ultramid™ B5) for the polymer filled with bentonite which had been hydrophobized showed an increase of the E-modulus of 58%, of the yield stress of 19% and of the temperature resistance by 15 degrees C.

1. A gas bag module for a vehicle occupant restraint system, comprising a gas generator, a carrier part for the gas generator, a gas bag associated with the gas generator, and a covering for the gas bag, characterized in that at least one of said carrier part and the covering comprises at least one layer composed of a polymer matrix and exfoliated layered silicate particles dispersed in said polymer matrix, the exfoliated layered silicate particles having a thickness of 0.5 to 2 nm and a surface diameter of up to 10 μm.

2. The gas bag module according to claim 1, characterized in that the layered silicate particles are present in a proportion of 1 to 6 parts by weight per 100 parts by weight of the polymer matrix.

3. The gas bag module according to claim 1, characterized in that the layered silicate particles are hydrophobized by treatment with an organic onium compound.

4. The gas bag module according to claim 3, characterized in that the organic onium compound is selected from the group consisting of compounds formed from amino acids and amino acid derivatives.

5. The gas bag module according to claim 1, characterized in that the exfoliated layered silicate particles are formed from a layered silicate selected from the group consisting of montmorrilonite, saponite, beidelite, nontronite, sauconite, stevensonite, hectorite, bentonite, vermiculite, halloysite, kaolin, calcium methasilicate, smectite and fluorosmectite.

6. The gas bag module according to claim 1, characterized in that the polymer matrix further comprises a coupling agent for bonding the exfoliated layered silicate particles with the polymer matrix.

7. The gas bag module according to claim 6, characterized in that the coupling agent is selected from the group consisting of organosilanes and polysiloxanes having terminal functional groups.

8. The gas bag module according to claim 7, characterized in that the coupling agent is selected from the group of aminosilanes, vinyl silanes, glyzidoxysilanes and polysiloxanols, and derivatives and mixtures thereof.

9. The gas bag module according to claim 1, characterized in that the polymer matrix is selected from the group of thermoplastic polymers and thermoplastic elastomers.

10. The gas bag module according to claim 1, characterized in that the polymer matrix comprises polyamide.
